(19) United States
(12) Patent Application Publication
(10) Pub. No.: US 2008/0316197 A1
(43) Pub. Date: Dec. 25, 2008

(54) CONSERVING POWER IN A COMPUTER SYSTEM

(76) Inventor: Manjunath DS, Bangalore (IN)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/143,668

(22) Filed: Jun. 20, 2008

(30) Foreign Application Priority Data
Jun. 22, 2007 (IN) 1348/DEL/2007

(51) Int. Cl. G06F 1/32

(52) U.S. Cl. 345/212

(57) ABSTRACT

A computer system may comprise a processor, a chipset, and a memory. The processor may enter low-power mode based on the occurrence of pre-specified events. A graphics controller of the chipset may drive the display such as the LVDS display panel to a self-refresh mode and then enter low-power mode. The display may refresh the pixels with the data persevered prior to entering the self-refresh mode. The memory and a memory controller of the chipset may also enter low-power mode. The graphics controller may enter normal mode after the processor enters the normal mode and may pull back the display to the normal mode.

This application claims priority to Indian Application Number 1348/DEL/2007 titled “Conserving Power In A Computer System”, filed Jun. 22, 2007.

### BACKGROUND

A computer system may comprise a processor, chipset, and I/O devices. The processor may enter a low-power mode in response to occurrences of specific events. For example, the processor may enter low-power mode after waiting for an activity on a bus to occur. Such an approach may conserve power. However, the other devices to which the processor is coupled may continue to operate in high-power or normal mode, while the processor is in low-power mode. The other devices, which continue to operate in normal mode may consume power.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computer system 100.

FIG. 2 illustrates an embodiment of the computer system 100 conserving power.

### DETAILED DESCRIPTION

The following description describes conserving power in a computer system. In the following description, numerous specific details such as logic implementations, resource partitioning, or sharing, or duplication implementations, types and interrelationships of system components, and logic partitioning or integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device).

For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, and digital signals). Further, firmware, software, routines, and instructions may be described herein as performing certain actions. However, it should be appreciated that such descriptions are merely for convenience and that such actions in fact result from computing devices, processors, controllers, and other devices executing the firmware, software, routines, and instructions.

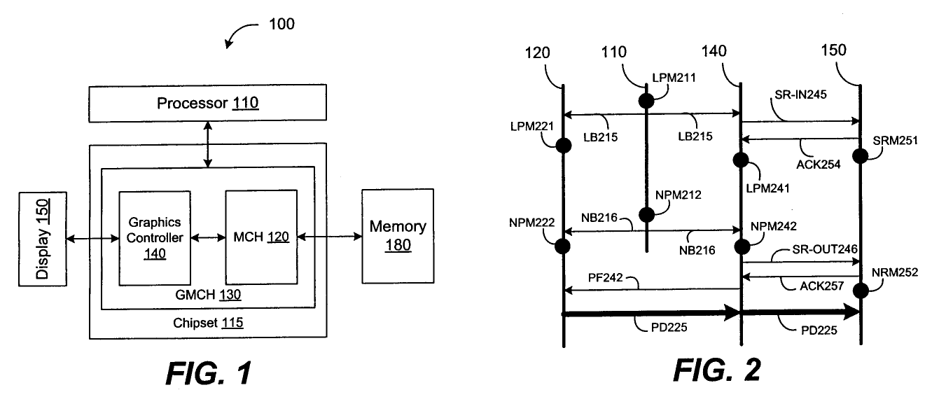

An embodiment of a computer system 100 is illustrated in FIG. 1. The computer system 100 may comprise a processor 110, a chipset 115, a display 150, and a memory 180. The memory 180 may store data and instructions and may comprise different types of memory devices such as DRAM (Dynamic Random Access Memory) devices, SDRAM (Synchronous DRAM) devices, DDR (Double Data Rate), or other volatile and non-volatile memory devices used in computers.

The processor 110 may manage various resources and processes within the computer system 100. In one embodiment, the processor 110 may comprise, for example, one or more microprocessors from Intel® family of microprocessors. The processor 110 may interface with the chipset 115 to retrieve data from the memory 180 and to store data into the memory 180. The processor 110 may be coupled to I/O devices through input-output interfaces such as a Serial Advanced Technology Attachment (SATA), Integrated Drive Electronics (IDE), Universal Serial Bus (USB), a Low Pin Count (LPC), or the peripheral component interconnect PCI/PCI-e interfaces.

In one embodiment, the processor 110 may enter a low-power mode from a high power or normal mode to save power consumed by the computer system 100. In one embodiment, the processor 110, before entering low-power mode, may wait for a pre-specified duration during which no activity is detected on the bus coupling the processor 110 to the chipset 115. In one embodiment, the operating system (OS) supported by the processor 110 may broadcast messages, which indicate that the processor 110 is entering a low-power mode such as ‘Cx’ states. In one embodiment, the OS may use advanced configuration and power interface (ACPI) to broadcast messages.

The chipset 115 may comprise one or more integrated circuits or chips that operatively couple the processor 110, the memory 180, and the devices coupled to one or more of the input-output interfaces or ports. The chipset 115 may be one from the family of Intel® chipsets. In one embodiment, the chipset 115 may comprise a graphics and memory controller hub (GMCH) 130.

In one embodiment, the GMCH 130 may process the transactions and transfer the corresponding data between the memory 180, input-output interfaces, the processor 110, and the display 150. An embodiment of the GMCH 130 may comprise a memory controller hub (MCH) 120 and a graphics controller 140. The MCH 120 may receive, process, and transmit packets generated by one of the processor 110, the memory 180, the graphics controller 140, and the I/O interfaces.

The graphics controller 140 may process the data before sending the data to the corresponding devices coupled to the GMCH130. In one embodiment, the graphics controller 140 may be coupled to the display 150 such as a low voltage differential signaling (LVDS) screen used as monitors, for example, in desktop, laptop, hand-held, mobile phone, personal digital assistant (PDA), tablet-PC, and such other similar devices. In one embodiment, the graphics controller 140 may receive video data, process the video data, and may then cause the video data to be displayed on the display 150.

In one embodiment, the graphics controller 140 may retrieve data from the memory 180 through MCH 120 to refresh the display 150. In one embodiment, the graphics controller 140 may refresh the LVDS panel at the rate of, for example, 60 frames per second. In one embodiment, the graphics controller 140 may wake-up the processor 110 from the low-power state to refresh the display 150. In one embodiment, the graphics controller 140 may comprise storage to store the pixels for refreshing the display 150 without interrupting the processor 110, which may be operating in low-power mode for specified time duration of X milli-seconds (ms). In one embodiment, the value of X may depend on the size of the storage unit.

As the processor 110 is interrupted once every X milli-seconds, the processor 110 may, frequently, re-enter the high-power or normal mode. The benefits of power conservation may not be optimum with such an approach. To improve power conservation, a buffer may be associated with the graphics controller 140 to increase the amount of data storage, which in turn may increase the specified duration to, for example, 3X. However, such an approach may not be scalable and also while the processor 110 is in low-power mode, the graphics controller 140 may still be in high-power mode or normal mode consuming power at a rated value.

In one embodiment, the graphics controller 140 may enter low-power mode in response to receiving the broadcast message, which may indicate that the processor 110 has entered low-power mode. In one embodiment, the graphics controller 140 may cause the display 150 to enter into a self-refresh mode before the graphics controller 140 may enter the low-power mode. In one embodiment, the graphics controller 140 may relinquish the low-power mode in response to receiving broadcast message, which may indicate that the processor 110 has relinquished the low-power mode. In one embodiment, the graphics controller 140, while relinquishing the low-power mode, may cause the display 150 to relinquish the self-refresh mode and enter the normal mode.

An embodiment of the computer system 100 conserving power is illustrated in FIG. 2. In one embodiment, the processor 110 may enter a low-power mode. In one embodiment, the event of the processor 110 entering low-power mode is depicted as LPM211. In one embodiment, the operating system supported by the processor 110 may detect the transition of the processor 110 from normal to low-power mode and may send a broadcast message LB215. In one embodiment, the LB215 may indicate that the processor 110 is in low-power mode. In one embodiment, the memory 180, MCH120, and graphics controller 140 may receive the broadcast message LB215 and, in response to receiving LB215, the memory 180 and MCH 120 may enter low-power mode. In one embodiment, the event of MCH120 entering low-power mode is represented by LPM221.

In one embodiment, the graphics controller 140 may send a first control packet SR-IN245 to the display 150. In one embodiment, SR-IN245 may instruct the display 150 to enter self-refresh mode (SRM). In one embodiment, the graphics controller 140 may use I2C protocol to send the control packet to the display 150. In one embodiment, the first control packet SR-IN245 may comprise three bytes: Byte1 (address of the memory location within the display 150 reserved for self-refresh mode) may equal 0x7F; Byte2 (Self-refresh Op-code) may equal 0xAB; and Byte3 (control byte) may equal 0x01. In one embodiment, the contents of Byte2 may represent a unique identifier for self-refresh mode and 0x01 in the control byte may instruct the display 150 to enter self-refresh mode.

In one embodiment, the display 150 may send a first acknowledgement ACK254 in response to receiving the control packet SR-IN245. In one embodiment, ACK245 may comprise two bytes: Byte1 (self-refresh Op-code) may equal 0xAB; and Byte2 (Acknowledge) may equal 0x02. In one embodiment, the display 150 may enter self-refresh mode from the next frame after sending ACK254. The self-refresh mode of display 150 may be depicted as SRM251. In one embodiment, the display 150 may preserve the RGB values of the pixels that were used prior to entering the self-refresh mode. In one embodiment, the display 150, while operating in SRM251, may apply appropriate voltage levels and the preserved RGB values to each transistor at regular intervals to refresh each pixel.

In one embodiment, the graphics controller 140 may enter low-power mode in response to receiving ACK254. The low-power mode of the graphics controller 140 is depicted as LPM241.

In one embodiment, the processor 110 may enter into active or normal mode. For example, the processor 110 may enter normal mode in response to receiving an interrupt from one of the devices coupled to the processor 110. The event of the processor 110 entering the normal mode is depicted as NPM212. In one embodiment, the OS may detect the event NPM212 and may send a broadcast message NB216. In response to receiving NB216, the MCH120 may enter the normal mode and the event is depicted by NPM222.

In one embodiment, the graphics controller 140 may also enter normal mode, which is depicted by NPM242. In one embodiment, the graphics controller 140 may send a second control packet SR-OUT246. In one embodiment, SR-OUT246 may comprise three bytes: Byte1 (address of the memory location within the display 150 reserved for self-refresh mode) may equal 0x7F; Byte2 (Self-refresh Op-code) may equal 0XAB; and Byte3 (control byte) may equal 0x00. In one embodiment, 0x00 in the control byte may instruct the display 150 to relinquish self-refresh mode SRM251.

In one embodiment, the display 150 may send a second acknowledgement ACK259 in response to receiving SR-OUT246. In one embodiment, ACK259 may comprise two bytes: Byte1 (self-refresh Op-code) may equal 0XAB; and Byte2 (Acknowledge) may equal 0x02. In one embodiment, the display 150 may relinquish SRM251 from the next frame after sending ACK259 and may enter normal refresh mode NRM252.

In one embodiment, the graphics controller 140 may send fetch pixel data signal PF242 to the MCH120. The graphics controller 140 may receive pixel data PD 225 and may in turn send PD225 to the display 150.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. An apparatus comprising a graphics controller coupled to a display unit, wherein the graphics controller is to enter low-power state after initiating the display unit to enter a self-refresh mode.

2. The apparatus of claim 1, wherein the graphics controller is to send a first signal to the display unit, wherein the first signal is to result in the display unit to refresh the pixels with pixel data sent by the graphics controller before entering low-power state.

3. The apparatus of claim 2, wherein the pixel data is to comprise values for red, green, and blue colors.

4. The apparatus of claim 2, wherein the first signal is in an inter-integrated circuit protocol format, wherein the first signal is to comprise a control byte programmed with a first value to indicate that the display unit has to enter the self-refresh mode.

5. The apparatus of claim 4, wherein the graphics controller is to generate the first signal after receiving a second signal, which is to indicate that a processor coupled to the graphics controller has entered a low-power state.

6. The apparatus of claim 5, wherein the graphics controller is to enter low-power state in response to receiving an acknowledgement to the first signal.

7. The apparatus of claim 6, wherein the first signal is to comprise an address byte, which comprises the address of the memory location within the display unit reserved for self-refresh mode.

8. A machine readable medium comprising a plurality of instructions that in response to being executed result in a graphics controller entering low-power state after initiating the display unit to enter a self-refresh mode, wherein the display unit is coupled to the graphics controller.

9. The machine readable medium of claim 9 comprises sending a first signal to the display unit, wherein the first signal is to result in the display unit to refresh the pixels with pixel data sent by the graphics controller before entering low-power state.

10. The machine readable medium of claim 9, wherein the pixel data is to comprise values for red, green, and blue colors.

11. The machine readable medium of claim 9 comprises programming a control byte of the first signal with a first value to indicate that the display unit has to enter the self-refresh mode, wherein the first signal is in an inter-integrated circuit protocol format.

12. The machine readable medium of claim 11 comprises generating the first signal after receiving a second signal, which is to indicate that a processor coupled to the graphics controller has entered a low-power state.

13. The machine readable medium of claim 12 comprises causing the graphics controller to enter low-power state in response to receiving an acknowledgement to the first signal.

14. The machine readable medium of claim 13, wherein the first signal is to comprise an address byte, which comprises the address of the memory location within the display unit reserved for self-refresh mode.

15. A system comprising:
a processor, wherein the processor is to enter low-power mode in response to determining non-occurrence of an activity for a specified duration,
a graphics memory controller hub coupled to the processor, wherein the graphics memory controller hub is to enter low-power state after initiating a display unit to enter a self-refresh mode in response to determining that the processor has entered low-power mode, and
the display unit coupled to the graphics memory controller hub, wherein the display unit is to enter the self-refresh mode in response to being initiated.

16. The system of claim 15, the graphics memory controller hub further comprises a graphics controller, wherein the graphics controller is to send a first signal to the display unit, wherein the first signal is to cause the display unit to refresh the pixels with pixel data sent by the graphics controller before entering low-power state.

17. The system of claim 16, the display unit further comprises a low voltage differential signaling display panel.

18. The system of claim 16, wherein the graphics controller is to set:
an address byte of the first signal to an address value of the memory location within the display unit reserved for self-refresh mode, and
a control byte of the first signal to a first value to indicate that the display unit has to enter the self-refresh mode,
wherein the first signal is in an inter-integrated circuit protocol format.

19. The system of claim 16, the graphics memory controller further comprises a memory controller coupled to a memory, wherein the memory controller is to transfer the pixel data from the memory to the graphics controller before entering low-power mode, wherein the memory controller and the memory is to enter low-power mode in response to determining that the processor has entered low-power mode.

20. The system of claim 16, wherein the graphics controller is to enter a normal power-mode in response to determining that the processor has entered normal-power and to cause the display unit to enter the normal mode thereafter.
